(19) United States
(12) Patent Application Publication
(10) Pub. No.: US 2007/0047722 A1
(43) Pub. Date: Mar. 1, 2007

(54) Telephone keypad with dot expression capability

(76) Inventor: Tetsunori Kunimune, Burhank, CA (US)

Correspondence Address: Eugene Oak, 818 N. Lake St., Burbank, CA, 91502, US

(21) Appl. No.: 11/214,185

(22) Filed: Aug. 30, 2005

(51) Int. Cl. H04M 1/00; H04M 3/00

(52) U.S. Cl. 379/368; 379/369

(57) ABSTRACT

A telephone keypad that enabling dial an alphabetic telephone number that has ‘.com’ therein is provided. The keypad has a key button having a numeric, for example “5”, at the center and “J”,“K”, “L”and “.” symbols surrounding the numeric “5”. The numeric can be any of one from 2, 3, 4, 5, 6, 7, 8, and 9. If the “.” places on numeric “2” button, the alphabetic symbols are “a”, “b”, and “c”. The telephone keypad makes it easy to remember the telephone number and Internet web site of one company at the same time.

### FIELD OF THE INVENTION

The present invention relates to a telephone keypad arrangement, more particularly to a keypad that can express a ‘.’ as a member of letter character.

### BACKGROUND OF THE INVENTION

With the wide spread of Internet, many companies have their home pages on the Internet with an address of ‘www. xxx. com.’ and more and more people search the information of a specific company from the Internet. Therefore, such kind of ‘. com.’ became more familiar as a representative address for a certain company. If a company having an Internet address of ‘. com.’ can have a phone number that can be called by pushing the same alphabetic name with a touch tone phone key pads, it will be more convenient for both of the customers and that company.

Unfortunately, most of ground touch-tone phones do not have a key representing a ‘.’ on keypad. Therefore it was impossible to press the phone number such as ‘1-800-mom.com’. Though some cellular phones have ‘.’ key pad, the ‘.’ has its own meaning and recognized as a ‘period’ by the cellular phone. To make the ‘.’ symbol work, a user must press a functional key first. Then the cellular phone recognize the ‘.’ as a period. A user cannot use the‘.’ key on a cellular phone to call a telephone number.

Meanwhile, many companies have phone number that can be represented in alphabet as ‘1-800-mom-hand’. Even though a user press the alphabetic code, the telephone itself recognize the number as ‘1-800-666-4263’. In other words, the alphabet phone number is not real but a kind of agreement to make users memorize the phone number easily. Therefore, if a telephone company and user make agreement and let one of the ‘number’ key express ‘.’ like ‘a’, ‘b’, and ‘c’ are expressed by the key ‘2’, then many companies will buy the telephone number such as ‘1-800-ATT.com’ or ‘1-800-SBC.com’, which has last four digits such as -5xxx, if the “.” Symbol places on the number “5” button.

It is purpose of the current invention to provide a telephone equipped with a keypad that enables dialing a telephone number, which can be represented as ‘XXX-YYY.com’.

### DESCRIPTION OF THE PRIOR ART

U. S. Pat. No. 6,707,793 to Yamashita illustrates an Internet communication system that comprises a plurality of ISDN (Integrated Services Digital network) lines, an Internet network connected to the ISDN lines using IP (Internet Protocol) as a common protocol, at least one button telephone apparatus connected to the ISDN lines, and at least one telephone unit connected to the button telephone apparatus, wherein the button telephone apparatus has a selecting means for selecting a conventional telephone function or an Internet telephone function, wherein when the selecting means selects the Internet telephone function, the button telephone apparatus converts dial data received from the telephone unit into an IP address, the dial data representing a call destination, converts data of the audio signal received from the telephone unit into IP packets, and transmits the IP packets to the Internet network. No telephone keypad is introduced which has a button with numeric “5”, “J”, “K”, and “L” in one button.

U.S. Pat. No. 5,253,940 to Abecassis illustrates enhancements to computer keyboards and calculator devices that permit a user to select the function and labelling of said device's numeric keypad to conform to either the 123 layout or the 789 layout. U.S. Pat. No. 5,339,358 to Danish, et al. illustrates a method and apparatus for the conversion of a standard push button telephone keypad into a data entry terminal permitting full alphanumeric DTMF entry through a telephone system to a file server for delivery to a service provider computer. U.S. Pat. No. 5,598,469 to Preker illustrates a Keypad for a communication instrument, particularly a subscriber's instrument for telephone communication illustrates a communication instrument has a housing for containing various electrical or electronic circuits and, on an operator side, a push button paid with predetermined functions being associated with the buttons.

U.S. Pat. No. 5,612,690 to Levy illustrates a key pad key cap symbols, which are placed at the interstices between key caps as well as at their centers. U.S. Pat. No. 5,666,113 to Logan illustrates system for using a touch-sensitive computer input touchpad for computer cursor control and keypad emulation in which the system senses a touch on the touchpad surface, resolves lateral touch movement after the touch, and establishes cursor control on resolution of sufficient lateral movement. U.S. Pat. No. 5,758,295 to Ahlberg, et al. illustratres a mobile radio terminal includes a display for outputting at least one menu. U.S. Pat. No. 5,841,374 to Abraham illustrates an improved key and keyboard arrangement for a compact word processor, the keyboard arrangement consisting of only twelve toggle keys with each key capable of seven finctions, six of the keys being operated in a tactile manner by the finger tips of each hand. U.S. Pat. No. 5,844,506 to Binstead illustrates a touchpad, which may include a keypad array, digitizing tablet, touch screen or an electronic mouse, is operable through a suitable dielectric medium. U.S. Pat. No. 5,852,414 to Yu, et al. illustrates a triangle shape 4-way switching button for entering alphanumeric data on a 10-key pad. U.S. Pat. No. 6,377,685 to Krishnan illustrates a cluster key arrangement may be mechanically configured or electronically configured.

None of the prior art introduced a telephone keypad that can be used to dial an alphabetic number represented as ‘xxx.com’.

### SUMMARY OF THE INVENTION

With the wide spread of Internet, many companies have their home pages on the Internet with an address of ‘www. xxx. com’. And more and more people search the information of a specific company from the ilnternet Therefore, such kind of ‘. com.’ became more familiar as a representative address for a certain company. If a company having an Internet address of ‘. com.’ can have a phone number that can be called by pushing the same alphabetic name with a touch tone phone key pads, it will be more convenient for both of the customers and that company. Unfortunately, most of ground touch-tone phones do not have a key representing a ‘.’ on keypad. Therefore it was impossible to press the phone number such as ‘1-800-mom.com’. Though some cellular phones have ‘.’ keypad, the ‘.’ has its own meaning and recognized as a ‘period’ by the cellular phone. Therefore, if a telephone company and user make agreement and let one of the ‘number’ key express ‘.’ like ‘a’, ‘b’, and ‘c’ are expressed by the key ‘2’, then many companies will buy the telephone number such as ‘1-800-ATT.com’. It is the object of the present invention to allow a telephone user to denote the “.” symbol by pressing the number key button to express an alphabetic phone number containing a “.” in the middle. The telephone keypad of the current application has a button with numeral at the center thereof and a “.” symbol plus other alphabetic symbols surrounding the numeral.

### BRIEF DESCRIPTION OF THE DRAWINGS

FIG. 1 is a front view of the telephone keypad of the current application.

FIG. 2 is a perspective drawing of a number “5” button having a “.” symbol.

### DETAILED DESCRIPTION OF THE PREFERRED EMBODIMENT

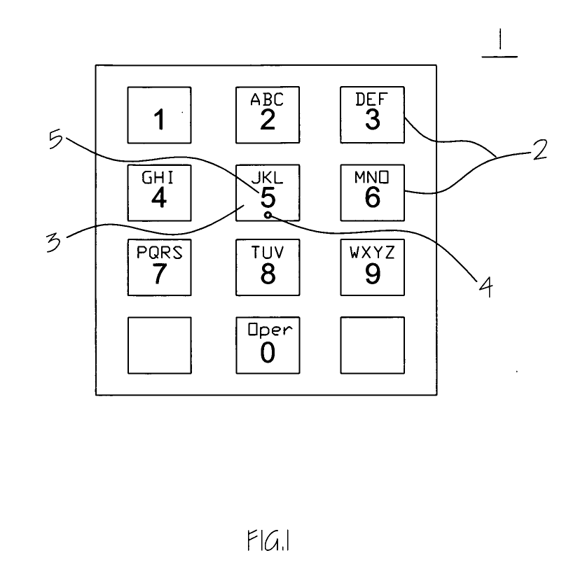

FIG. 1 is a front view of the telephone keypad (1) of the current application. The keypad (1) is comprised of twelve buttons (2). Each button (2) denotes a different number and various letters of the alphabet. Usually those letters of alphabet are printed with the same color of that of the numbers. It is a commonly seen set up for a telephone keypad matrix and is very well known in the prior art. Major difference from the prior arts is that any one number button between 2 to 9 can have “.” symbol on the upper face with the proper alphabetic symbols surrounding the number. If the “.” symbol places on the number 2 button, the alphabet symbols are “a”, “b”, and “c”. Likewise, if the “.” places on the number 3 button, then the alphabet symbols are “d”, “e”, and “f”. Table 1. shows the possible combination of the “.” symbol and alphabet symbols in one botton.

TABLE 1

| Number | Symbols |
|---|---|
| 2 | “.”, “a”, “b”, “c” |
| 3 | “.”, “d”, “e”, “f” |
| 4 | “.”, “g”, “h”, “i” |
| 5 | “.”, “j”, “k”, “l” |
| 6 | “.”, “m”, “n”, “o” |
| 7 | “.”, “p”, “q”, “r”, “s” |
| 8 | “.”, “t”, “u”, “v” |
| 9 | “.”, “w”, “x”, “y”, “z” |

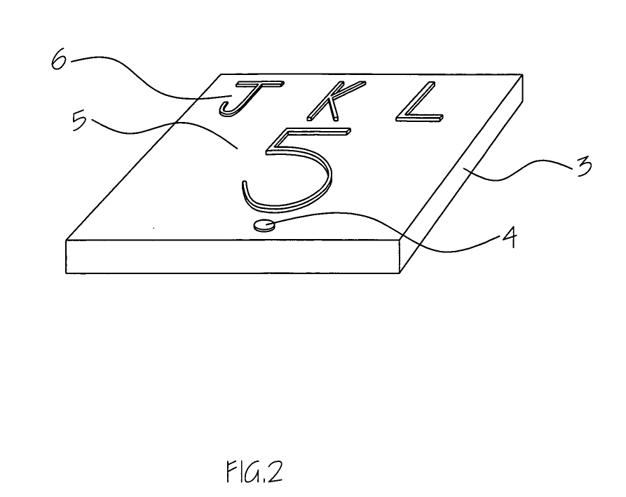

Let's select the number 5 as an example. Then the number “5” button (3) of the current application has a “.” symbol (4) that locates around and/or on the number “5” (5) on the upper surface of the button (3). Other alphabetic symbols (6) “J”, “K”, and “L” are located around the number “5” (5). FIG. 2 is a perspective drawing of the button (3) having a “.” symbol (4). The “.” symbol (4) has the same color with the other alphabetic symbols (6) and the number “5” (5). It is to teach users that the symbol “.” has the same function as the other alphabetic symbols (6). The “.” symbol (4) is raised from the surface of the button to inform users that a new symbol is added.

When a user press the “.” symbol (4), the telephone acknowledge it as number 5 just like the other alphabetic symbols (6) “J”, “K”, and “L”.

For example, if a user presses the toll free number of 1-800-ABC.com, the telephone calls a number 1-800-222-5266. The “.” symbol (4) may locate on any one button of different number between 2 to 9.

What is claimed is:

1. A telephone keypad, which has a button, having a numeral at the center of the surface surrounded by designated alphabets and a symbol “.”, all of which have same color and are acknowledged as the designated number when press the button.

2. A telephone keypad of claim 1, wherein the number is 2 when the designated alphalbets are “a”, “b”, and “c”.

3. A telephone keypad of claim 1, wherein the number is 3 when the designated alphalbets are “d”, “e”, and “f”.

4. A telephone keypad of claim 1, wherein the number is 4 when the designated alphalbets are “g”, “h”, and “i”.

5. A telephone keypad of claim 1, wherein the number is 5 when the designated alphalbets are “j”, “k”, and “1l”.

6. A telephone keypad of claim 1, wherein the number is 6 when the designated alphalbets are “m”, “n”, and “o”.

7. A telephone keypad of claim 1, wherein the number is 7 when the designated alphalbets are “p”, “q”, and “r”, and “s”.

8. A telephone keypad of claim 1, wherein the number is 8 when the designated alphalbets are “t”, “u”, and “v”.

9. A telephone keypad of claim 1, wherein the number is 9 when the designated alphalbets are “w”, “x”, “y”, and “f”.
